(19) United States
(12) Patent Application Publication
(10) Pub. No.: US 2013/0209100 A1
(43) Pub. Date: Aug. 15, 2013

(54) SYSTEM ARCHITECTURE FOR OPTICAL SWITCH USING WAVELENGTH DIVISION MULTIPLEXING

(71) Applicants: David Markham Drury, Pittsburgh, PA (US); David Jeffrey Graham, Sewickley, PA (US); Eric John Helmsen, Wexford, PA (US)

(72) Inventors: David Markham Drury, Pittsburgh, PA (US); David Jeffrey Graham, Sewickley, PA (US); Eric John Helmsen, Wexford, PA (US)

(73) Assignee: Accipiter Systems, Inc., Wexford, PA (US)

(21) Appl. No.: 13/372,716

(22) Filed: Feb. 14, 2012

(51) Int. Cl. H04J 14/02

(52) U.S. Cl. 398/48

(57) ABSTRACT

A system for transmitting data on an optical burst network. The system includes an optical core configured to switch data bursts based upon a wavelength of the data bursts. The system also includes a plurality of switch port devices operably connected to the optical core, wherein at least one of the plurality of switch port devices is configured to transfer the data bursts to the optical core and at least one of the plurality of switch port devices is configured to receive the data bursts from the optical core. The system further includes at least one control plane processor operably connected to the plurality of switch port devices and configured to transmit scheduling information to at least one of the plurality of switch port devices configured to transfer the data bursts to the optical core.

### BACKGROUND

The disclosed embodiments generally relate to the fields of optical networks, data switching and data routing. More specifically, the disclosed embodiments generally relate to an optical interface for operably connecting a switch or routing device to an end device.

Recently, telecommunication systems and data networking systems have rapidly grown in speed and capacity. Accompanying the growth of these systems, however, has been the cost of maintaining these systems. A typical network, such as a local area network (LAN), requires a large and costly infrastructure. For example, groups of servers must be included in the LAN to handle requests from users of the LAN, direct these requests accordingly, maintain various shared files and other resources, and provide a gateway to other networks, such as the Internet. In addition to the servers, each LAN must have a series of routers and switches to direct traffic generated by the users of the LAN. The servers, switches and routers, as well as the users' computers must all be connected via cabling or a wireless connection. These various devices and connections all require significant power, cooling, space and financial resources to ensure proper functionality.

Fiber optic cables have been used to replace standard coaxial or copper-based connections in communication networks. Fiber optic cables typically use glass or plastic to propagate light through a network. Specialized transmitters and receivers utilize the propagating light to send data through the fiber optic cables from one device to another. Fiber optic cables are especially advantageous for long-distance communications, because light propagates through the fibers with little attenuation as compared to electrical cables. This allows long distances to be spanned with few repeaters, thereby reducing the cost of a communication network.

In fiber-optic communications, wavelength-division multiplexing (WDM) is a technology that multiplexes multiple optical carrier signals on a single optical fiber by using different wavelengths of light to carry different signals. In this way, WDM allows for a multiplication in capacity.

A WDM system typically uses a multiplexer to join multiple optical carrier signals together at a transmitter, and a demultiplexer at the receiver to split the multiplexed signal into its original optical carrier signals. WDM systems are generally broken into three different wavelength patterns: conventional, coarse and dense.

Conventional WDM systems employ channel spacing on the order of 400 MHz and typically use wavelengths in the “C” band between 1530 and 1565 nm (see Table 1 below). The channel spacing, however, restricted the number of multiplexed wavelengths to between 8 and 16.

Dense Wave Division Multiplexing (DWDM) also refers to optical signals multiplexed within the 1530-1565 nm “C” band, but with much closer channel spacing and, therefore, the ability to multiplex additional optical channels. 100 GHz spacing, resulting in 40 channels, and 50 GHz channel spacing, resulting in 80 channels in the “C” band, are both common for DWDM systems, with some DWDM systems supporting alternative channel spacing such as 25 GHz.

Alternatively, coarse WDM (CWDM) systems use the entire frequency band from 1260 to 1675 nm with 20 nm channel spacing, thereby resulting in lower cost and less sophisticated transceiver designs.

Table 1 provides a list of band designations specified by the International Telecommunication Union for the main transmission regions of fiber optic cables and the wavelength ranges covered by each transmission region. Typically, DWDM falls into the 1530-1565 nm range, however, advances in materials and construction methods for optical fibers has increased this range to nearly the entire range of main transmission regions, i.e., 1260-1675 nm.

TABLE 1
ITU Standard Optical Band Definitions

| Band | Descriptor | Wavelength Range |
|---|---|---|
| O band | Original | 1260-1360 nm |
| E band | Extended | 1360-1460 nm |
| S band | Short Wavelength | 1460-1530 nm |
| C band | Conventional | 1530-1565 nm |
| L band | Long Wavelength | 1565-1625 nm |
| U band | Ultralong Wavelength | 1625-1675 nm |

As both communication systems grow and fiber optic systems become more integrated into standard communications, the speed, and resultant cost, of individual network components is also growing. Huge investments must be made by telecommunication companies to keep up with consumer demand as well as technological developments. As a result, telecommunication companies as well as businesses running their own communication networks would benefit greatly from network components with reduced size, weight, cost and power requirements. However, development has progressed slowly in this area. Instead, network components are simply made bigger and heavier, and consume more power in the pursuit of supplying higher bandwidth.

In atypical environments, such as airborne or shipborne networks, size, weight and power become even more important for network design. However, the lack of progress in reducing the size, weight and power of network components described above has restricted the availability of high-bandwidth networks in such environments.

For example, space is at a premium on most airplanes and smaller ships. As such, network components of the size used in most business environments could exceed the available storage space in such environments. Data networks capable of providing on-demand video and audio programming to airplane passengers have developed slowly at least because of the size of conventional networking equipment. Similarly, military aircraft often require high-speed communication between subsystems or are used as a flying communication hub. However, conventional networking equipment is limited in its ability to perform this task because of the limited footprint that can be provided to all functions in an aircraft.

In addition, the weight of a network component has a direct effect on fuel consumption in airborne or shipborne environments because the added weight increases the drag on the airplane or ship. Similarly, the amount of power consumed by network components directly affects fuel consumption since power in airborne and shipborne environments is generated within the environment itself. For ships that are at sea for long periods of time, the power consumed by conventional networking equipment inhibits the ability to use such equipment because of the drain on limited energy reserves.

Prior art approaches at reducing the size of switching components generally require data routing at the network core, resulting in buffering (and inherent latency) to queue the data flows at the core. Alternatively, prior art approaches have eliminated some switching functions by establishing direct, out-of-band connections. However, this arrangement requires time consuming and complex setup and tear down.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

In one general respect, the embodiments disclose a system for transmitting data on an optical burst network. The system includes an optical core configured to switch data bursts based upon a wavelength of the data bursts; a plurality of switch port devices operably connected to the optical core, wherein at least one of the plurality of switch port devices is configured to transfer the data bursts to the optical core and at least one of the plurality of switch port devices is configured to receive the data bursts from the optical core; and at least one control plane processor operably connected to the plurality of switch port devices and configured to transmit scheduling information to at least one of the plurality of switch port devices configured to transfer the data bursts to the optical core.

In another general respect, the embodiments disclose a method of transmitting data on an optical burst network. The method includes receiving, at a first switch port device, data from at least one end device; assigning, by the first switch port device, at least one wavelength to the data, wherein the wavelength is based upon a destination of the data; transmitting, by the first switch port device, the data at the at least one assigned wavelength to an optical core operably connected to the first switch port device; switching, by the optical core, the data based upon a wavelength of the data; receiving, at a second switch port device operably connected to the optical core, the switched data from the optical core; determining, by the second switch port device, a destination end device for the data; and transmitting, by the second switch port device, the data to the destination end device.

### BRIEF DESCRIPTION OF THE DRAWINGS

FIG. 1 shows an illustrative optical network according to an embodiment.

FIG. 2 shows an illustrative switch for use in the network of FIG. 1 including a switch port device according to an embodiment.

FIG. 3 shows an illustrative switch port device of FIG. 2 according to an embodiment.

FIG. shows an illustrative optical core and control plane of FIG. 2 according to an embodiment.

FIG. 5 shows an illustrative process for transferring data through an optical burst network.

### DETAILED DESCRIPTION

The following terms shall have, for the purposes of this application, the respective meanings set forth below.

A “burst” refers to a sequence of bits of information transmitted by a node, a burst including, but not limited to, raw data, framed data, or data arranged into packets prior to transmission. A burst may be transmitted from one node to one or more destination nodes over a network.

A “node” refers to a system (e.g., processor-based, field programmable gate array (FPGA) based or memory-based) configured to transmit and/or receive information from one or more other nodes via a network. For example, a node may transmit to one or more destination nodes by varying the frequency of its transmissions to match a frequency at which its burst is switched to a specific destination node.

A “switch” refers to a network component that provides bridging and/or switching functionality between a plurality of nodes. A switch may have a plurality of inputs and a corresponding number of outputs. Each node may be operably connected to a switch via both an input fiber and an output fiber.

An “Optical Burst” (OB) network refers to a network constructed from a plurality of nodes and one or more switches. An OB network uses optical transmissions to send data bursts between a source node and one or more destination nodes.

An “end device” is a network component that exists at the edge of a network. End devices may be components that end users interact with to access the network, including, but not limited to, computers and workstations. An end device may also be a component that an end user does not directly interact with, including, but not limited to, email servers and web servers. An end device may include one or more end device interfaces for operably connecting to the network.

Terabit Optical Ethernet (“TOE”) is a network architecture and transmission protocol that may be used to implement local, wide and/or metropolitan area networks. An exemplary TOE may be found in U.S. Pat. No. 7,751,709 filed Jan. 18, 2006 and entitled “Method and System for Interconnecting End Systems over an Optical Network,” the contents of which are hereby incorporated by reference. TOE may transmit 100s of terabits of information per second over single mode fibers that are common today. TOE is a highly scalable architecture allowing controlled access to a common shared fiber media.

In the present disclosure, the underlying principles of TOE have been used to provide an alternative architecture providing a better match to specific requirements of large, concentrated assemblies of processors and storage devices in an OB network.

An OB network resolves these problems by removing layers of conventional infrastructure equipment. Moreover, power, cooling and packaging costs are dramatically reduced as a result of the reduction in physical infrastructure. In addition, an OB network is easily scalable and can benefit from increases in optical technologies for improved bandwidth over time. An OB network is inherently transparent to the nature of the bursts carried over it, and may be designed to carry Ethernet traffic by providing Ethernet interfaces to connected computer systems, PCI Express traffic through PCI Express interfaces, Fiber Channel through Fiber Channel interfaces, and so forth. OB and methods of using OB networks to reduce network costs by interfacing various computer systems via an optical switch are discussed below with reference to the figures.

An illustrative OB network as discussed herein may include at least three basic elements: a plurality of nodes, at least one switching device and a plurality of optical fibers. Each node may include one or more transceivers used to access the optical fibers. An optical transceiver may be an integrated circuit configured to transmit and receive a signal via an optical fiber. An optical fiber is typically a glass or plastic tube configured to carry an optical signal. In the exemplary OB network as discussed herein, an optical fiber (single-mode or multi-mode) may be used to link each node to the switching device, thereby establishing a network, such as a LAN.

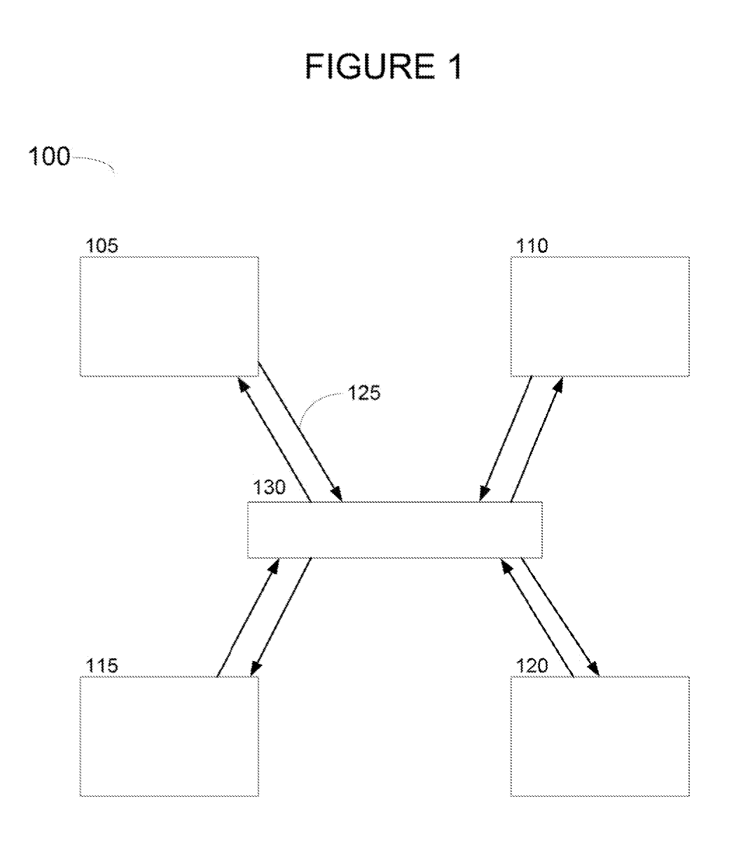

FIG. 1 shows an illustrative system level diagram of an exemplary OB network 100. The OB network 100 may include four nodes 105, 110, 115 and 120 interconnected by a series of optical fibers 125 to a switch 130. Optical fibers include, but are not limited to, single-mode and multi-mode fibers. Each node may be connected to both an input terminal and an output terminal of the switch 130.

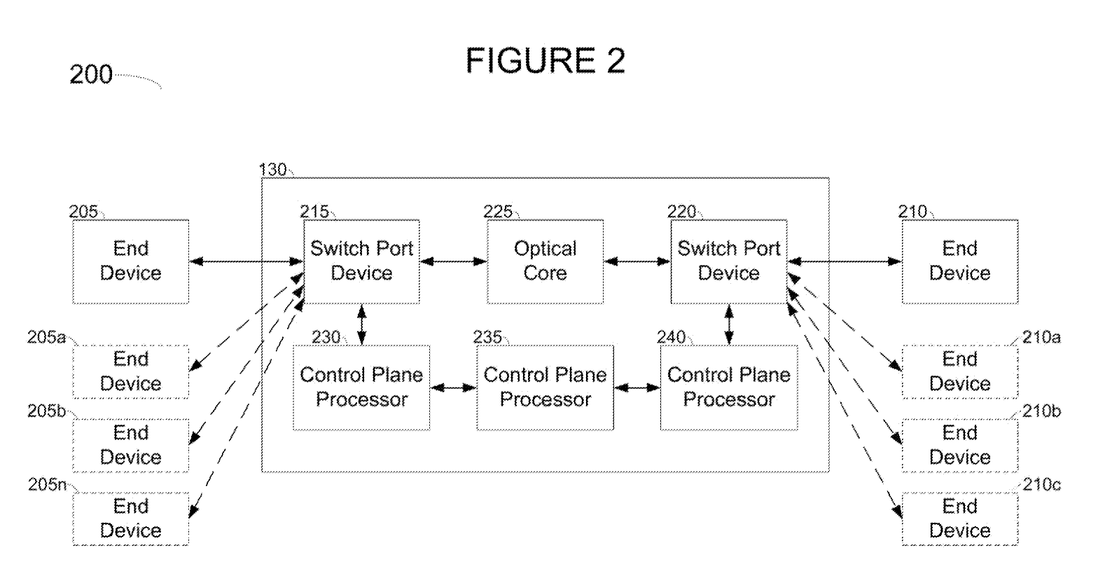

In order for one node to transmit data to another node, the source node transmits data to the switch 130 with the intended destination information contained within the data stream. For example, node 105 may send a burst intended for node 120. The node 105 may transmit the burst to switch 130. The switch 130 may receive the data and direct the data to the output destination node 120 accordingly. The internal architecture of the switch 130 is discussed in greater detail below with respect to FIG. 2.

FIG. 2 shows an illustrative OB network 200 including an illustrative architecture for the switch 130. The switch 130 may be operably connected to a first end device 205 (e.g., one of nodes 105, 110, 115 and 120) and a second end device 210 (e.g., one of nodes 105, 110, 115 and 120).

Each of the end devices 205 and 210 may be operably connected to one of switch port device 215 and switch port device 220 respectively. A switch port device is an optical interface device configured to operably connect end devices to the optical core. Each switch port device 215 and 220 may be configured to receive incoming data from an end device, determine the destination of the data (e.g., one of nodes 105, 110, 115 or 120 as shown in FIG. 1), and modulate the data into a burst of the appropriate wavelength or wavelengths such that the burst reaches the intended destination switch port device(s), where the burst is reformatted into data for transmission to the appropriate end device(s).

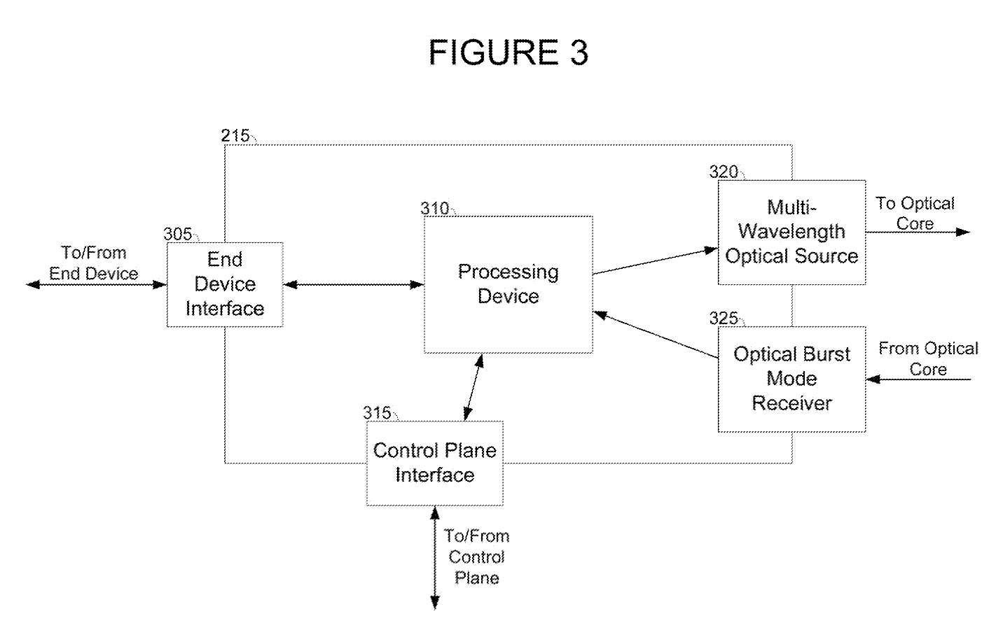

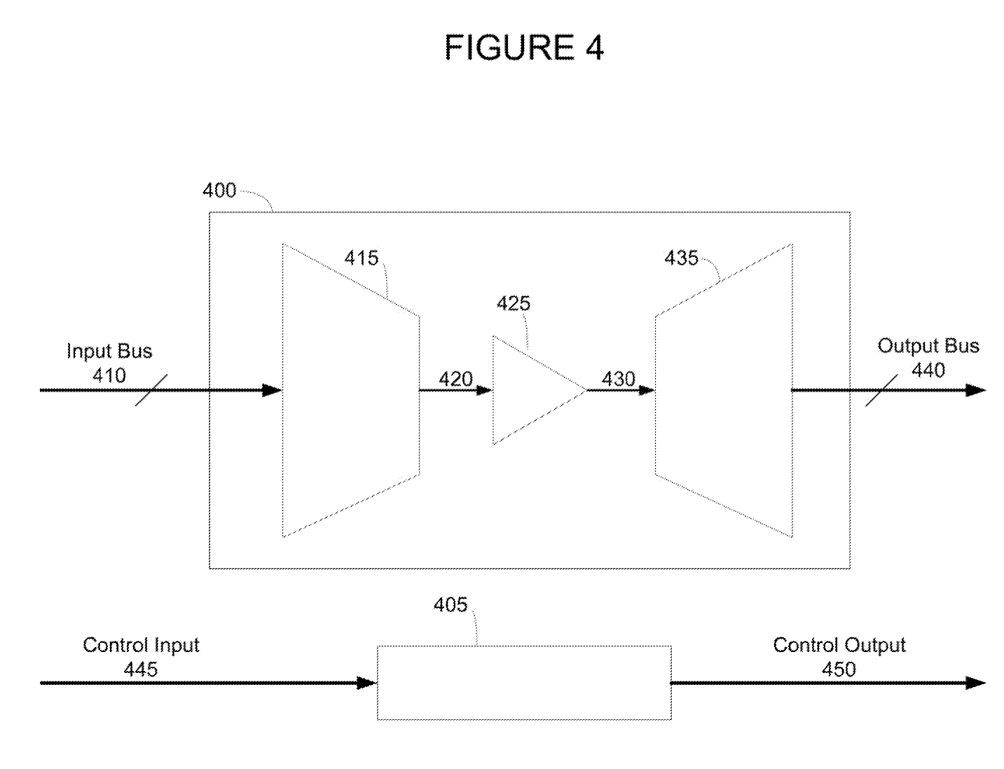

FIG. 3 shows an illustrative architecture for a switch port device such as switch port device 215 as shown in FIG. 2. The switch port device 215 may include an end device interface 305 for operably connecting to an end device such as end device 205 as shown in FIG. 2. The end device interface 305 may be configured to establish bi-directional communication between the switch port device 215 and the end device. The operable connection between the end device interface 305 and the end device may be media independent. For example, the connection may be electrical, optical, wireless, and so forth. The switch port device 215 may receive data from the end device via the end device interface 305 as raw and unformatted data, or formatted in an interconnect standard such as PCI Express, Fiber Channel, Ethernet, or another similar interconnect standard.

The end device interface 305 may be operably connected to computation and queuing logic, such as processing device 310. The processing device 310 may be configured to receive incoming data from the end device interface 305 and process the data for transmission to an intended destination device. Processing the data may include determining and assigning a wavelength for transmitting the data based upon an assigned wavelength for the intended destination. The processing device 310 may be an application specific integrated circuit (ASIC), an FPGA, a microprocessor, or another similar processing device.

The processing device 310 may be further connected to a control plane interface 315 for sending information to and receiving information from a control plane processor. The processing device 310 may send an indication to the control plane via the control plane interface 315 indicating there is data to be sent to a destination node. The control plane interface 315 may receive scheduling information from the control plane processor indicating when the switch port device 215 can transmit the data to the optical core. Based upon the scheduling information, the processing device 310 may queue the data for a certain time period, or direct the data to a multi-wavelength optical source 320 for transmission to the optical core. The multi-wavelength optical source 320 may be a tunable laser configured to produce a signal on one of a plurality of wavelengths. Alternatively, the multi-wavelength optical source 320 may be a laser array including a plurality of lasers, each of which is tuned to a unique wavelength. The multi-wavelength optical source 320 may also be a combination of tunable lasers and a laser array.

The switch port device 215 may also include an optical burst mode receiver 325 operably connected to the optical core and configured to receive incoming optical bursts from the optical core. The optical burst mode receiver 325 may include photo-detection circuitry such as an optical sensor for detecting the incoming optical bursts as well as timing and data recovery circuitry for the incoming optical bursts. The optical burst mode receiver may be further configured to pass any incoming optical bursts to the processing device 310 for further processing and forwarding to an appropriate end device as determined by the content of the incoming optical bursts.

Additional detail and examples related to switch port devices are shown in U.S. application Ser. No. 13/276,924 filed Oct. 19, 2011 and titled “Optical Interface Device for Wavelength Division Multiplexing Networks,” the content of which is hereby incorporated by reference in its entirety, and U.S. application Ser. No. 13/276,977 filed Oct. 19, 2011 and titled “Switch with Optical Uplink for Implementing Wavelength Division Multiplexing Networks,” the content of which is hereby incorporated by reference in its entirety.

It should be noted the number and arrangement of components as shown in FIG. 3 is by way of example only and may be modified depending on the implementation of the switch port device 215. For example, multiple end device interfaces 305 may be included for connecting the switch port device 215 to a plurality of end devices, such as end devices 205a, 205b, . . . , 205n as shown in FIG. 2.

Referring again to FIG. 2, each of switch port devices 215 and 220 may be operably connected to an optical core 225 and one or more control plane processors 230, 235 and 240. The optical core 225, in combination with the control plane processors 230, 235 and 240, may be configured to switch and direct data bursts based upon their wavelength. An example of an optical core is shown in U.S. patent application Ser. No. 13/035,045 filed Feb. 25, 2011 and titled “Optical Switch for Implementing Wave Division Multiplexing Networks,” the content of which is hereby incorporated by reference in its entirety. The control plane processors 230, 235 and 240 may be configured to control data flow from the switch port devices 215 and 220 to the optical core 225. The control plane processors 230, 235 and 240 may schedule transmissions over the optical core such that only one burst is being sent to a destination at one time, thereby eliminating the chances of a burst being lost during transmission.

It should be noted that three control plane processors 230, 235 and 240 are shown by way of example only. In an alternative embodiment, a single control plane processor may by used to control data flow through the optical core. The number of control plane processors may be determined by the layout of the OB network as well as the amount of traffic and related information to be processed, and thus may vary depending on the application and design of the network.

FIG. 4 shows an illustrative optical core 400 (e.g., optical core 225 as shown in FIG. 2) and a control plane processor 405 (e.g., one or more of control plane processors 230, 235, 240 as shown in FIG. 2). The optical core 400 may include an input bus 410 from one or more switch port devices such as switch port device 215 as shown in FIG. 2. The input bus 410 may be passed to a combiner 415. The combiner 415 may be configured such that each of the input signals on the input bus 410 is combined or multiplexed into a single wavelength division multiplexing (WDM) output signal 420.

The WDM output signal 420 may be directed via an optic fiber to an amplifier 425. The amplifier 425 may output a boosted WDM output signal 430 to a splitting function or splitting element. The splitting element may be arranged and configured such that the boosted WDM output signal 430 is demultiplexed into individual signal components. Examples of splitting elements may include an arrayed waveguide grating (AWG), an optical splitter, and other similar devices configured to demultiplex an optical signal, such as the boosted WDM output signal 430, into one or more output components. As shown in FIG. 4, the exemplary optical core may include an AWG 435. The AWG 435 may be configured such that it operates as an optical demultiplexer by receiving the boosted WDM output signal 430, demultiplexing the signal into its individual components, each having an associated wavelength, and directing each individual signal component to an appropriate optical fiber of output bus 440 based upon the individual component's associated wavelength.

In an alternative embodiment, the optical core 400 may include an arrayed wavelength grating router (AWGR). An AWGR functions similarly to the AWG 435 as described above. However, an AWGR is configured to receive a plurality of input signals as opposed to a single input signal as used with an AWG.

In addition to the optical core 400, a switch port device may also be operably connected to one or more control plane processors 405 via a control plane interface (e.g., control plane interface 315 as shown in FIG. 3). The switch port device may be further configured to transfer a control input signal 445 to the control plane processor 405. The control input signal 445 may include information related to bursts queued for transmission such as their destination and priority. The control plane processor 405 may be configured to receive the control input signal 445, process the input signal, and output a control output signal 450. The control output signal 450 may indicate to the requesting switch port device when the switch port device may transmit a data burst.

Additional detail and examples related to an optical core and control plane processor(s) is shown in U.S. application Ser. No. 13/276,805 filed Oct. 19, 2011 and titled “Optical Switch for Networks Using Wavelength Division Multiplexing,” the content of which is hereby incorporated by reference in its entirety.

Referring again to FIG. 2, the optical core 230 may be operably connected to switch port device 220, and thus to end devices 210, 210a, 210b, . . . , 210n. This arrangement provides an efficient solution for delivering data across an optical core (e.g., from end device 205 to end device 210) while maintaining low latency and a high quality of service resulting from the integration of the control plane, resulting in no blocking, no data collisions and no loss. The arrangement takes advantage of the inherent strengths of optical technology for high speed data throughput as well as the inherent strengths of silicon for logical operations and queuing.

It should be noted the arrangement and architecture of OB network as shown in FIG. 2 is shown by way of example only. For example, the placement of the switch port devices 215 and 220 are shown by way of example only. In an alternative embodiment, the switch port devices may be integrated in the end devices as a network interface card (NIC) such as a PCI Express NIC. Similarly, the switch port devices 215 and 220 may be a stand-alone unit such as a top-of-rack fabric extender on a server rack. The switch port devices 215 and 220 may also be integrated in the optical core itself, for example, as a line card.

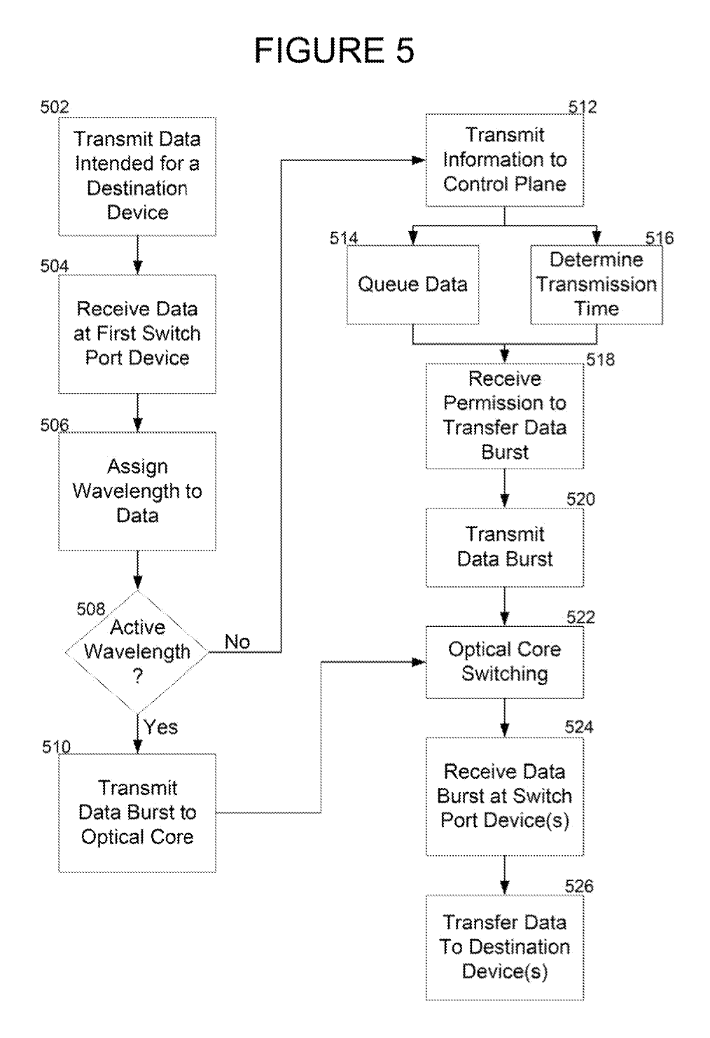

FIG. 5 shows an illustrative process for transferring data through an exemplary OB network such as OB network 200 as shown in FIG. 2. An end device may transmit 502 data intended for a destination device to a switch port device. For example, the end device may transmit a data stream via a wired connect to the switch port device, the data stream including the data intended for the destination device as well as addressing information indicating the destination device. The switch port device may receive 504 the data and determine the destination of the data from information contained therein. Based upon the destination of the data, the switch port device may assign 506 a wavelength to the data such that the data is corrected switched through the optical core to one or more appropriate switch port devices for transferring to the destination device(s). Alternatively, the assignment 506 of the wavelength may be based upon other aspects of the data or through management configuration information.

The switch port device may determine 508 whether the assigned 506 wavelength is an active wavelength, e.g., are data bursts currently being sent via that wavelength through the optical core. If the switch port device determines 508 the wavelength is an active wavelength, the switch port device may transmit 510 the data burst to the optical core. Otherwise, the switch port device may transmit 512 information related to the data to the control plane and queue 514 the data until the control plane responds with scheduling information related to the transmission of the data through the optical core. The control plane may receive the information related to the data and determine 516 a specific transmission time for the switch port device to transmit the data to the optical core. The specific transmission time may be based upon the current level of traffic passing through the optical core, the next free time period for transmitting a data burst via the assigned 506 wavelength, and other information related to the present level of traffic through the optical core. This specific transmission time ensures that no other switch port devices will attempt to transfer through the optical core to the same end device at the same time, thus eliminating collisions within the optical core. The control plane may also select a specific transmission time such that any existing quality of service parameters guaranteed for that data will be met.

After a period of time, the switch port device may receive 518 permission from the control plane to transfer the data burst to the optical core via the specific scheduling information. In response to receiving permission 518, the switch port device may transmit 520 the data burst to the optical core. Transmitting 520 may include modulating the data to the assigned 506 wavelength and transmitting the data burst through the optical core.

Once the switch port device transmits 510, 520 the data burst to the optical core, the optical core may switch 522 the data based upon the wavelength of the optical burst. As discussed above, the optical core may be designed such that any incoming data bursts are switched to an appropriate output based upon the wavelength of the optical burst. One or more destination switch port devices may receive 524 the switched 522 data burst, determine the destination end device(s), reformat the data burst, and transfer 526 the data to the destination device(s). Prior to transferring 526 the data to the destination device(s), the one or more destination switch port devices may perform various functions on the data such as error checks, timing corrections, error corrections, data reassembly, burst mode clock and data recovery, and other similar functions. The one or more destination switch port devices may also transmit an acknowledgement to the control plane, indicating the data burst was received at the one or more switch port devices.

It should be noted that the control plane as discussed above in reference to FIGS. 2, 3 and 4 may operate on separate wavelengths from the data plane while sharing common optic fibers. Alternatively, the control plane may operate with separate optic fibers from the data plane or operate on a completely separate communication medium such as copper wire. If on fiber, the control plane signals may be in parallel with data plane signals or in-band with data plane signals on different time allocations.

It should also be noted that the switch as shown in FIG. 2 may be modified accordingly based upon the requirements of a network that the switches are integrated into. It should also be noted that while the disclosed embodiments refer to switch data operating over Ethernet, the switches may also be used with alternate and/or additional networking protocols. For example, a switch, such as switch 130, may be integrated into an InfiniBand network or other computer cluster protocols, a Fiber Channel or other storage protocol (e.g., iSCSI) network, an Asynchronous Transfer Mode network, or another similar switched fabric network protocol configured to transfer data between nodes.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A system for transmitting data on an optical burst network, the system comprising:
an optical core configured to switch data bursts based upon a wavelength of the data bursts;
a plurality of switch port devices operably connected to the optical core, wherein at least one of the plurality of switch port devices is configured to transfer the data bursts to the optical core and at least one of the plurality of switch port devices is configured to receive the data bursts from the optical core; and
at least one control plane processor operably connected to the plurality of switch port devices and configured to transmit scheduling information to at least one of the plurality of switch port devices configured to transfer the data bursts to the optical core.

2. The system of claim 1, wherein each of the plurality of switch port devices comprises:
a first end device interface configured to receive incoming data from a first end device and intended for a destination device;
a processing device operably connected to the first end device interface and configured to control the modulation of the incoming data to a wavelength associated with the destination device to produce a modulated burst;
an optical transmitter operably connected to the processing device and configured to transmit the modulated burst to the optical core; and
an optical receiver operably connected to the processing device and configured to receive at least one incoming optical burst from the optical core.

3. The system of claim 2, wherein each of the plurality of switch port devices further comprises a control plane interface operably connected to the processing device and configured to communicate with the at least one control plane processor.

4. The system of claim 2, wherein the processing device is further configured to queue the incoming data based upon the scheduling information.

5. The system of claim 2, wherein the processing device is further configured to transfer the modulated burst to the optical transmitter based upon the scheduling instruction.

6. The system of claim 2, wherein the optical transmitter is at least one of a tunable laser and a laser array.

7. The system of claim 2, wherein the optical receiver comprises clock and data recovery circuitry for at least one incoming optical burst.

8. The system of claim 1, wherein the optical core comprises:
at least one coupling element operably connected to two inputs and configured to combine at least two received input signals into a combined output signal; and
a splitting element operably connected to the at least one coupling element and configured to demultiplex the combined output signal to produce a plurality of demultiplexed output signals.

9. The system of claim 8, wherein the splitting element comprises an arrayed wavelength guide (AWG).

10. The system of claim 9, wherein the AWG is tuned to direct each of the plurality of demultiplexed output signals signal to a specific output based upon a wavelength of each of the plurality of demultiplexed output signals.

11. The system of claim 1, wherein the at least one control plane processor is further configured to schedule transmission of the data bursts such that a destination output receives a single transmitted data burst at a particular instance of time.

12. A method of transmitting data on an optical burst network, the method comprising:
receiving, at a first switch port device, data from at least one end device;
assigning, by the first switch port device, at least one wavelength to the data, wherein the wavelength is based upon a destination of the data;
transmitting, by the first switch port device, the data at the at least one assigned wavelength to an optical core operably connected to the first switch port device;
switching, by the optical core, the data based upon a wavelength of the data;
receiving, at a second switch port device operably connected to the optical core, the switched data from the optical core;
determining, by the second switch port device, a destination end device for the data; and
transmitting, by the second switch port device, the data to the destination end device.

13. The method of claim 12, further comprising transferring, by the first switch port device, information to a control plane processor related to the data.

14. The method of claim 13, further comprising receiving, by the first switch port device, scheduling information from the control plane processor.

15. The method of claim 14, further comprising queuing, by the first switch port device, the data based upon the scheduling information.

16. The method of claim 14, wherein the transmitting further comprises transmitting the data to the optical core based upon the scheduling information.

17. The method of claim 12, further comprising performing, by the second switch port device, burst mode clock and data recovery on the at least one optical burst.
